(19) United States
(12) Patent Application Publication
(10) Pub. No.: US 2018/0041680 A1
(43) Pub. Date: Feb. 8, 2018

(54) FLEXIBLE TRANSMISSION LINE CAPABLE OF IMMOBILIZING CAMERA LENS ASSEMBLY, AND CAMERA WITH FLEXIBLE TRANSMISSION LINE

(71) Applicant: EYS3D MICROELECTRONICS,CO., Taipei City (TW)

(72) Inventor: Chao-Chun LU, Taipei City (TW)

(73) Assignee: EYS3D MICROELECTRONICS,CO., Taipei City (TW)

(21) Appl. No.: 15/413,327

(22) Filed: Jan. 23, 2017

(30) Foreign Application Priority Data
Aug. 4, 2016 (TW) 105211806

(51) Int. Cl. H04N 5/232; H01R 35/02; H04N 5/225

(52) U.S. Cl. CPC H04N 5/2328; H04N 5/23238; H04N 5/2254; H01R 35/02

(57) ABSTRACT

Disclosed are a flexible transmission line capable of immobilizing a camera lens assembly, and a camera with the flexible transmission line. The flexible transmission line includes a flexible pipe sleeve, a first connector and a second connector. The first connector and the second connector are respectively disposed to two ends of the flexible pipe sleeve.

The second connector is electrically connected to the first connector. The camera includes a flexible pipe sleeve, a first connector and a camera lens assembly. The first connector and the camera lens assembly are respectively disposed to two ends of the flexible pipe sleeve, and the camera lens assembly is electrically connected to the first connector.

### CROSS-REFERENCE TO RELATED APPLICATIONS

This non-provisional application claims priority under 35 U.S.C. § 119(a) on Patent Application No(s). 105211806 filed in Taiwan, R.O.C. on Aug. 4, 2016, the entire contents of which are hereby incorporated by reference.

### TECHNICAL FIELD

The disclosure relates to a transmission line and a camera, more particularly to a flexible transmission line capable of immobilizing a camera lens assembly, and a camera with the flexible transmission line.

### BACKGROUND

For a modern ball panorama camera, a number of camera lens assemblies are arranged in a spherical shape and simultaneously capture images of an ambient scene. Then, these images and overlaps therebetween are edited to produce a panorama image by a computer. Such a ball panorama camera generally cooperates with a mobile device, such as a cell phone, tablet computer, laptop computer or other suitable electronic device.

When a ball panorama camera and a mobile device are carried by a user's hands to capture images, hand shaking may easily cause blurred images or low image quality. However, due to the image capturing characteristics of the ball panorama camera, it is not suitable to dispose the ball panorama camera on a table for photographing.

### SUMMARY

According to one or more embodiments, the disclosure provides a flexible transmission line capable of immobilizing a camera lens assembly. The flexible transmission line includes a flexible pipe sleeve, a first connector and a second connector. The first connector is disposed at an end of the flexible pipe sleeve. The second connector is disposed at the other end of the flexible pipe sleeve. The second connector is electrically connected to the first connector and is pluggable to be electrically connected to the camera lens assembly. A portion of either the first connector or the flexible pipe sleeve is used as a supporting point to support the second connector.

According to one or more embodiments, the disclosure provides a camera with a flexible transmission line. The camera includes a flexible pipe sleeve, a first connector and a camera lens assembly. The first connector is disposed at an end of the flexible pipe sleeve. The camera lens assembly is disposed at the other end of the flexible pipe sleeve, and the camera lens assembly is electrically connected to the first connector. A portion of either the first connector or the flexible pipe sleeve is used as a supporting point to support the camera lens assembly.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of the use of a flexible transmission line according to an embodiment of the disclosure.

FIG. 2 is a schematic view of immobilizing a camera lens assembly and a mobile device via a flexible transmission line according to an embodiment of the disclosure.

FIG. 3 is a schematic view of immobilizing a camera lens assembly and a mobile device via a flexible transmission line according to another embodiment of the disclosure.

FIG. 4 is a schematic view of immobilizing a camera lens assembly and a mobile device via a flexible transmission line according to another embodiment of the disclosure.

FIG. 5 is a schematic view of immobilizing a camera lens assembly and a mobile device via a flexible transmission line according to another embodiment of the disclosure.

FIG. 6 is a schematic view of immobilizing a camera lens assembly and a mobile device via a flexible transmission line according to another embodiment of the disclosure.

FIG. 7 is a schematic view of a camera with a flexible transmission line according to an embodiment of the disclosure.

FIG. 8 is a schematic view of a camera with a flexible transmission line according to an embodiment of the disclosure.

FIG. 9 is a schematic view of a camera with a flexible transmission line according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

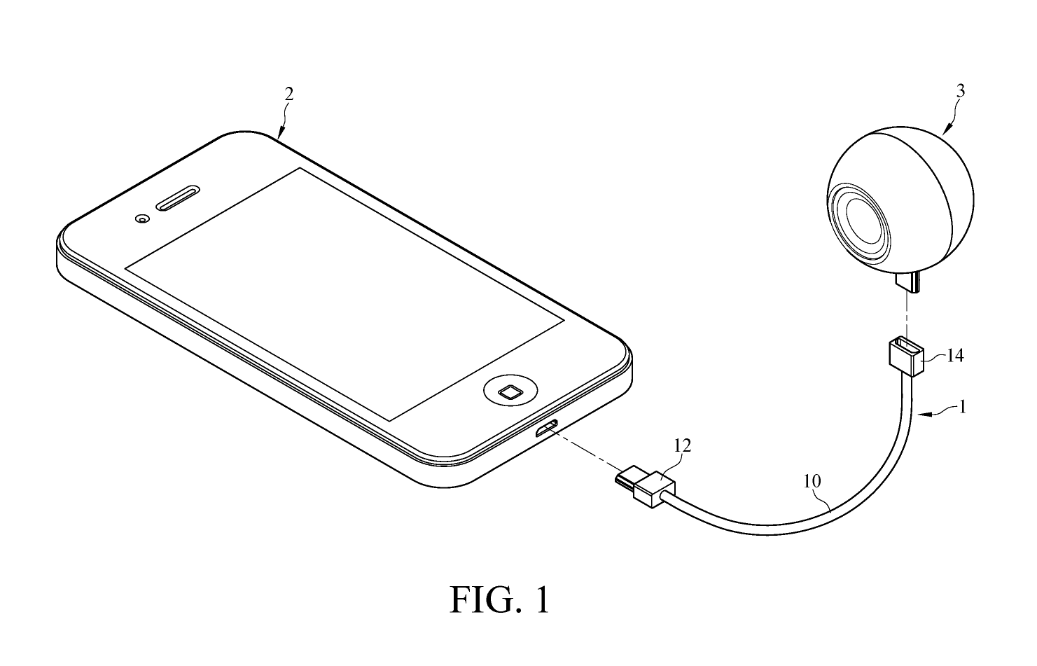

Please refer to FIG. 1. FIG. 1 is a schematic view of the use of a flexible transmission line according to an embodiment of the disclosure. As shown in FIG. 1, a flexible transmission line 1 includes a flexible pipe sleeve 10, a first connector 12 and a second connector 14. The flexible pipe sleeve 10 is not limited to be made of metal, silica gel or other suitable material. Because of the flexibility and strength of the material, the flexible pipe sleeve 10 can be bended to have any shape, such as an L shape, a U shape, a W shape or other suitable shapes while being subjected to an external force. A transmission conductor or one or more other suitable transmission arrangements are disposed to the inner side of the flexible pipe sleeve 10 to electrically connect the first connector 12 and the second connector 14 to each other.

The first connector 12 and the second connector 14 are respectively disposed to two opposite ends of the flexible pipe sleeve 10, so as to be electrically connected to electronic devices disposed at the two ends of the flexible pipe sleeve 10, respectively. For example, the electronic device is a camera, a smart phone, a tablet computer, a laptop computer, a desktop computer host or other suitable device. The transmission protocol of the first connector 12 and the transmission protocol of the second connector 14 are the micro USB, the USB type A, the USB type B, the USB type C, Lightning or other transmission protocol for the electronic device. In practice, since the first connector 12 is electrically connected to a mobile device 2 (i.e. external electronic device), the first connector 12 is, for example, a USB plug (also known as USB male connecter) to plug in a USB socket (also known as USB female connecter) on the mobile device 2; the second connector 14 is electrically connected to a camera lens assembly 3, so the second connector 14 is, for example, a USB socket to be plugged in by a USB plug on the camera lens assembly 3; and however, the disclosure is not limited to this. In other words, the first connector 12 and the second connector 14 are pluggable to be electrically connected to the mobile device 2 and the camera lens assembly 3.

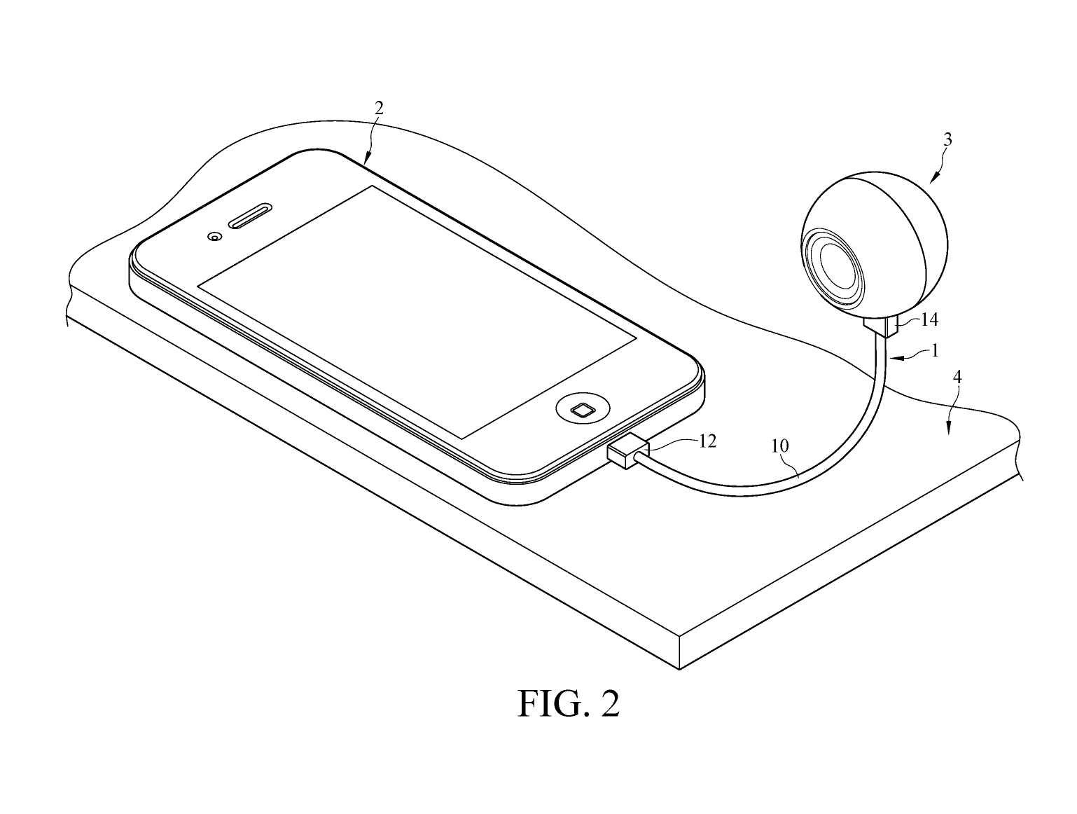

To clarify how to use the flexible transmission line 1 in this embodiment, please refer to FIG. 1 and FIG. 2. FIG. 2 is a schematic view of immobilizing a camera lens assembly and a mobile device via a flexible transmission line according to an embodiment of the disclosure. As shown in the figures, the first connector 12 at one end of the flexible pipe sleeve 10 is electrically connected to the mobile device 2 and the second connector 14 at the other end of the flexible pipe sleeve 10 is electrically connected to the camera lens assembly 3, so the mobile device 2 and the camera lens assembly 3 are electrically connected to each other via the flexible transmission line 1. For example, the camera lens assembly 3 sends captured image data to the mobile device 2 via the flexible transmission line 1 while the mobile device 2 powers the camera lens assembly 3 via the flexible transmission line 1, so the mobile device 2 can display the real-time or non-real-time images captured by the camera lens assembly 3.

When the flexible transmission line 1 uses the first connector 12 as a supporting point and supports the second connector 14, one end of the flexible pipe sleeve 10 is disposed on a plane 4 because of the mobile device 2 and the flexible pipe sleeve 10 is directly bended so that the other end of the flexible pipe sleeve 10 extends upward from the mobile device 2 to prop up the camera lens assembly 3. In other words, all of the flexible pipe sleeve 10, the camera lens assembly 3, the first connector 12 and the mobile device 2 do not contact the plane 4 together. The mobile device 2 and the flexible pipe sleeve 10 constitute a supporting stand for setting up the camera lens assembly 3 so that the camera lens assembly 3 can be set up on the plane 4 and capture images in the stability of the plane 4. Therefore, it may be avoided that the image quality is lowered by hand shaking if the user carries the mobile device 2 and the camera lens assembly 3 by hands to capture images.

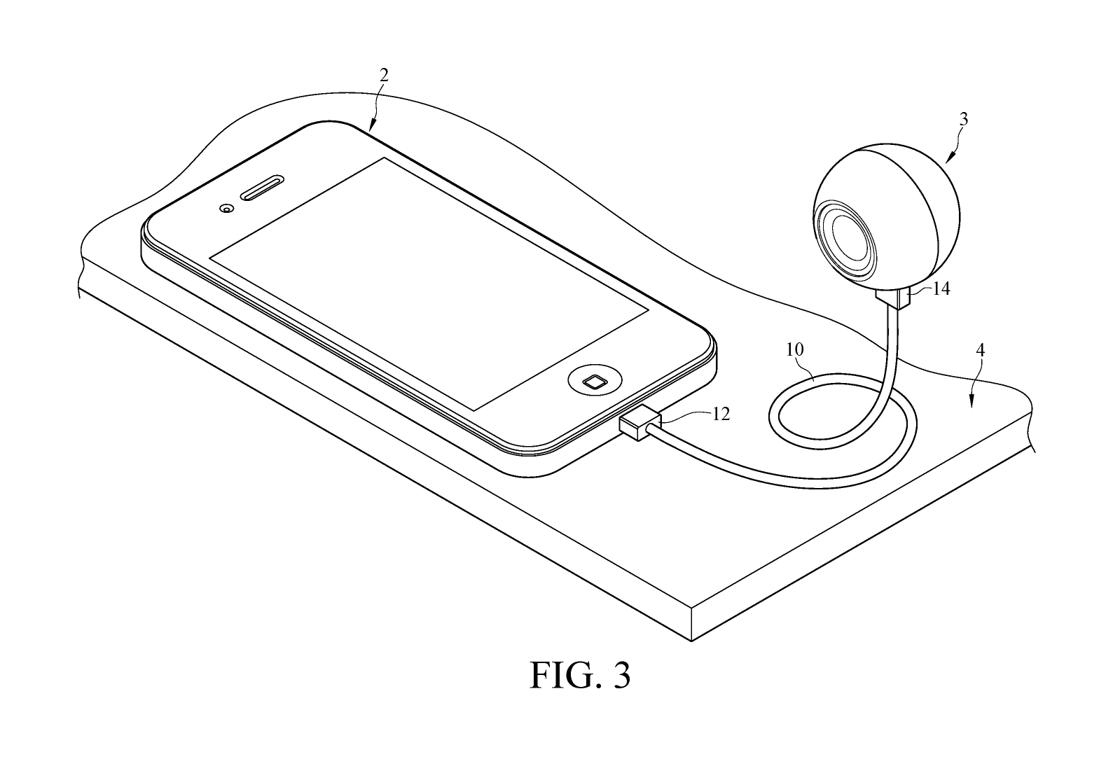

Another situation of immobilizing a camera lens assembly and a mobile device via a flexible transmission line is exemplarily explained by referring to FIG. 1 and FIG. 3. FIG. 3 is a schematic view of immobilizing a camera lens assembly and a mobile device via a flexible transmission line according to another embodiment of the disclosure. As shown in the figures, in addition to using the first connector 12 as a supporting point, the flexible transmission line 1 further uses a part of the flexible pipe sleeve 10 as a supporting point to support the second connector 14. For example, when the flexible pipe sleeve 10 is blended to have a L-shape, the bended portion of the flexible pipe sleeve 10 may contact and press against the plane 4. That is, one end of the flexible pipe sleeve 10 is disposed on the plane 4 because of the mobile device 2, and the other end of the flexible pipe sleeve 10 extends upward from the bended portion of the flexible pipe sleeve 10 in order to prop up the camera lens assembly 3. The flexible pipe sleeve 10 can be bended or form a ring shape or a multi-ring shape, but the disclosure is not limited thereto. The mobile device 2 and the flexible pipe sleeve 10 constitute a supporting stand to set up the camera lens assembly 3 so that the camera lens assembly 3 can be propped up on the plane 4 to stably capture images. Therefore, it may be avoided that the image quality is lowered by hand shaking if the user carries the mobile device 2 and the camera lens assembly 3 by hands to capture images.

As described above, the camera lens assembly 3 is a cam with a camera lens in an embodiment. Optionally, the camera lens assembly 3 is a cam with two camera lenses in another embodiment, and the two camera lenses are disposed oppositely so that the camera lens assembly 3 can capture images of front and back scenes via the two camera lenses. For example, the camera lens is a fisheye lens. The disclosure does not intend to limit the design of the camera lens assembly 3, and all those having ordinary skill in the art can design the camera lens assembly 3 according to practical requirements.

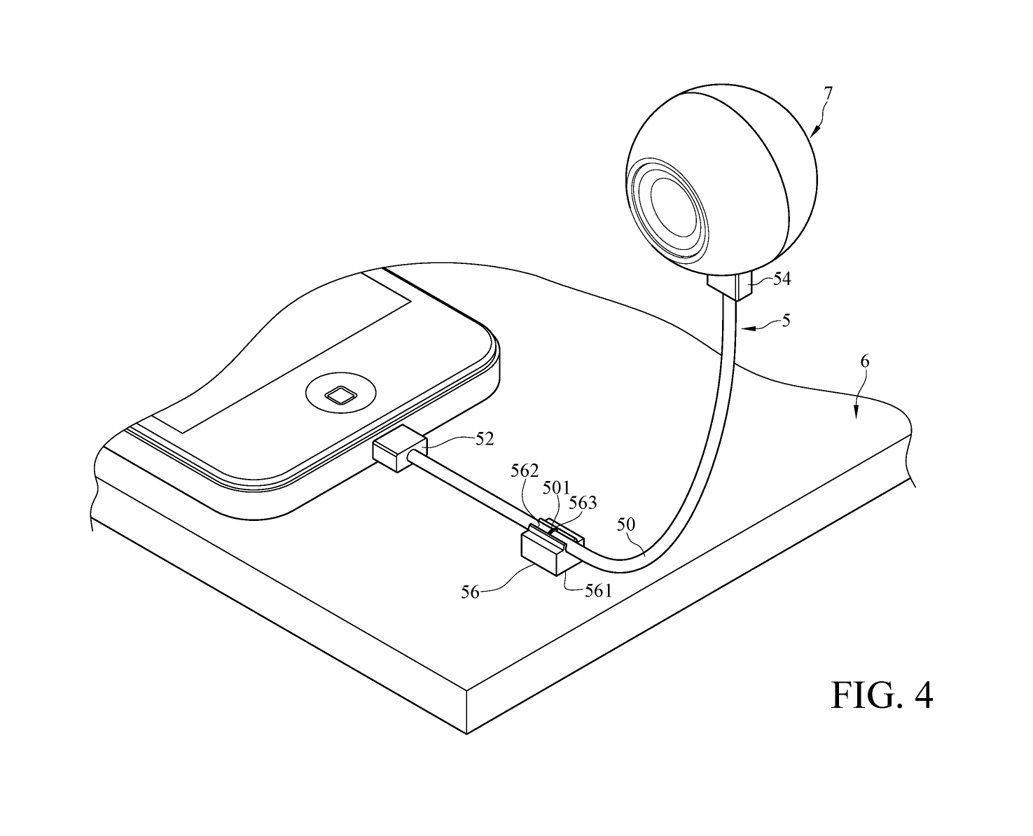

Next, please refer to FIG. 4. FIG. 4 is a schematic view of immobilizing a camera lens assembly and a mobile device via a flexible transmission line according to another embodiment of the disclosure. As shown in the figures, in addition to a flexible pipe sleeve 50, a first connector 52 and a second connector 54, a flexible transmission line 5 further includes a supporter 56 that is detachable and allows the flexible pipe sleeve 50 to be disposed through it. The supporter 56 has a supporting surface 561 and a bearing surface 562 opposite to the supporting surface 561. The bearing surface 562 is bent inwards to the supporting surface 561 and slidably contacts the flexible pipe sleeve 50. The supporting surface 561 is able to support the flexible pipe sleeve 50 on the plane 6 when the flexible transmission line 5 uses a part of the flexible pipe sleeve 50 as a supporting point, and thus, the end of the flexible pipe sleeve 50 for immobilizing a camera lens assembly 7 extends upward to prop up the camera lens assembly 7 after the flexible pipe sleeve 50 is blended. In another embodiment, the supporter 56 is selectively moved on the flexible pipe sleeve 50 to prop up the camera lens assembly 7 in cooperation with a part of the flexible pipe sleeve 50, so as to enhance the supporting effect of the flexible pipe sleeve 50.

In an embodiment, the external surface of the flexible pipe sleeve 50 has a first positioning structure 501, and the supporter 56 has a second positioning structure 563 corresponding to the first positioning structure 501. The second positioning structure 563 of the supporter 56 is fastened to the first positioning structure 501 of the flexible pipe sleeve 50 so that the supporter 56 is positioned on the external surface of the flexible pipe sleeve 50. In practice, the first positioning structure 501 is, for example, a bulge ring while the bearing surface 562 has a groove, so the supporter 56 is positioned at the external surface of the flexible pipe sleeve 50 via the bulge ring disposed in the groove.

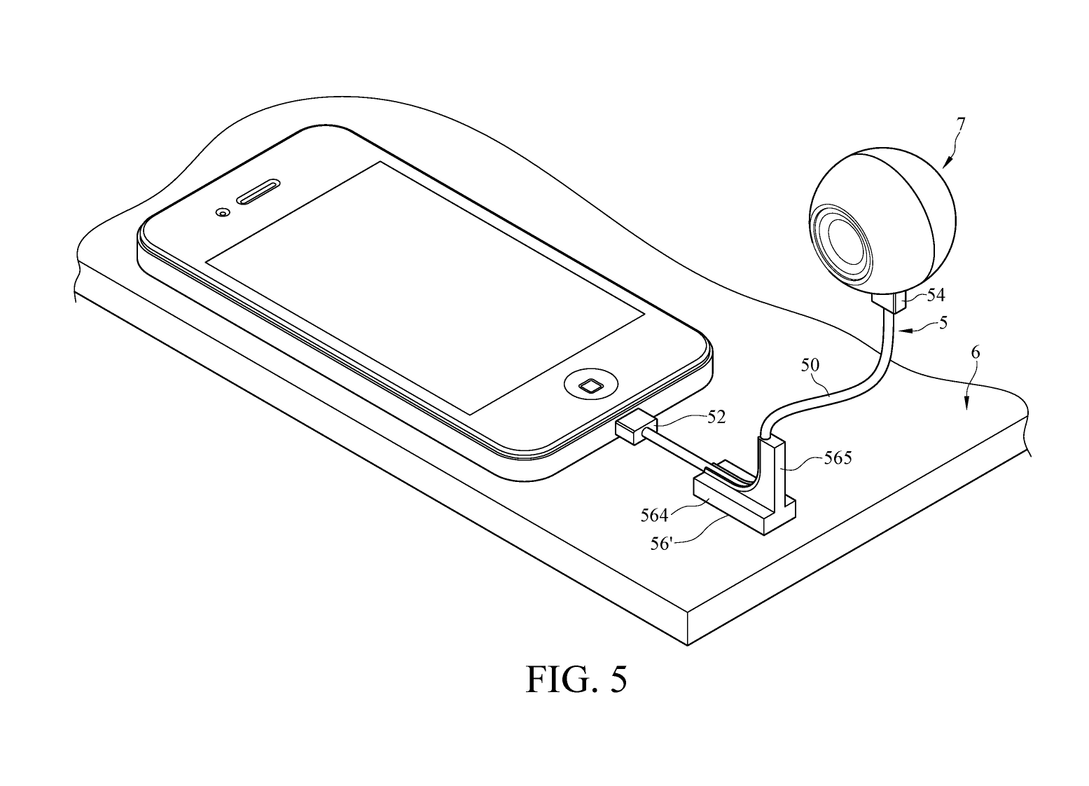

Another embodiment of immobilizing a camera lens assembly and a mobile device via a flexible transmission line is exemplarily explained with reference to FIG. 5. FIG. 5 is a schematic view of immobilizing a camera lens assembly and a mobile device via a flexible transmission line according to another embodiment of the disclosure. As shown in FIG. 5, a supporter 56′ includes a base section 564 and an upright section 565. The base section 564 and the upright section 565 have an angle therebetween, and the base section 564 and the upright section 565 have a concave for accommodating the flexible pipe sleeve 50. Therefore, the supporter 56′ is detachable and allows the flexible pipe sleeve 50 to be disposed through it. In practice, the flexible pipe sleeve 50 is bended by the angle between the base section 564 and the upright section 565 so that a part of the flexible pipe sleeve 50 at the upright section 565 may more strongly prop up the camera lens assembly 7.

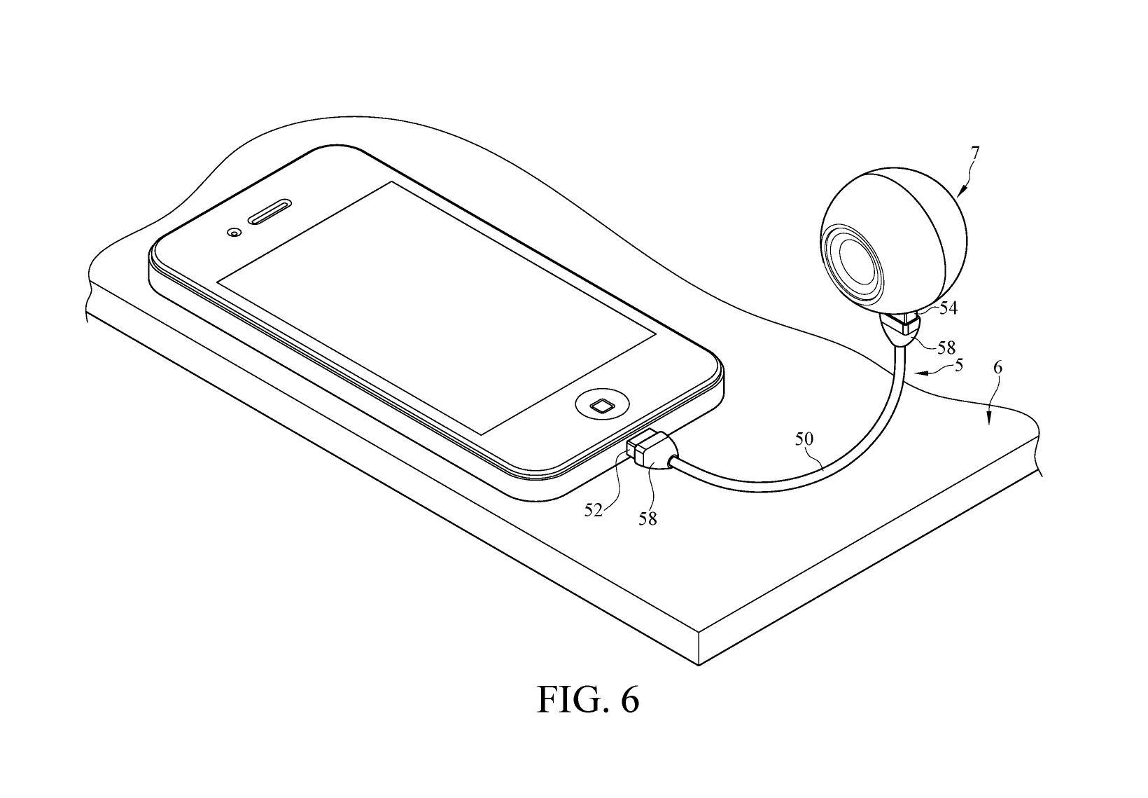

Another embodiment of immobilizing a camera lens assembly and a mobile device via a flexible transmission line is exemplarily explained with reference to FIG. 6. FIG. 6 is a schematic view of immobilizing a camera lens assembly and a mobile device via a flexible transmission line according to another embodiment of the disclosure. As shown in FIG. 6, the first connector 52 and the second connector 54 are directly connected to the outside of the flexible pipe sleeve 50, and covers 58 are further disposed and cover between the flexible pipe sleeve 50 and the first connector 52 and between the flexible pipe sleeve 50 and the second connector 54, respectively, so as to enhance the connection strength between the first connector 52 and the flexible pipe sleeve 50 and the connection strength between the second connector 54 and the flexible pipe sleeve 50.

As described above, the camera lens assembly 7 is a cam with a camera lens in an embodiment. Optionally, the camera lens assembly 7 is a cam with two camera lenses in another embodiment, and the two camera lenses are disposed oppositely so that the camera lens assembly 7 can capture images of front and back scenes via the two camera lenses. For example, the camera lens is a fisheye lens. The disclosure does not intend to limit the design of the camera lens assembly 7, and all those having ordinary skill in the art can design the camera lens assembly 7 according to practical requirements.

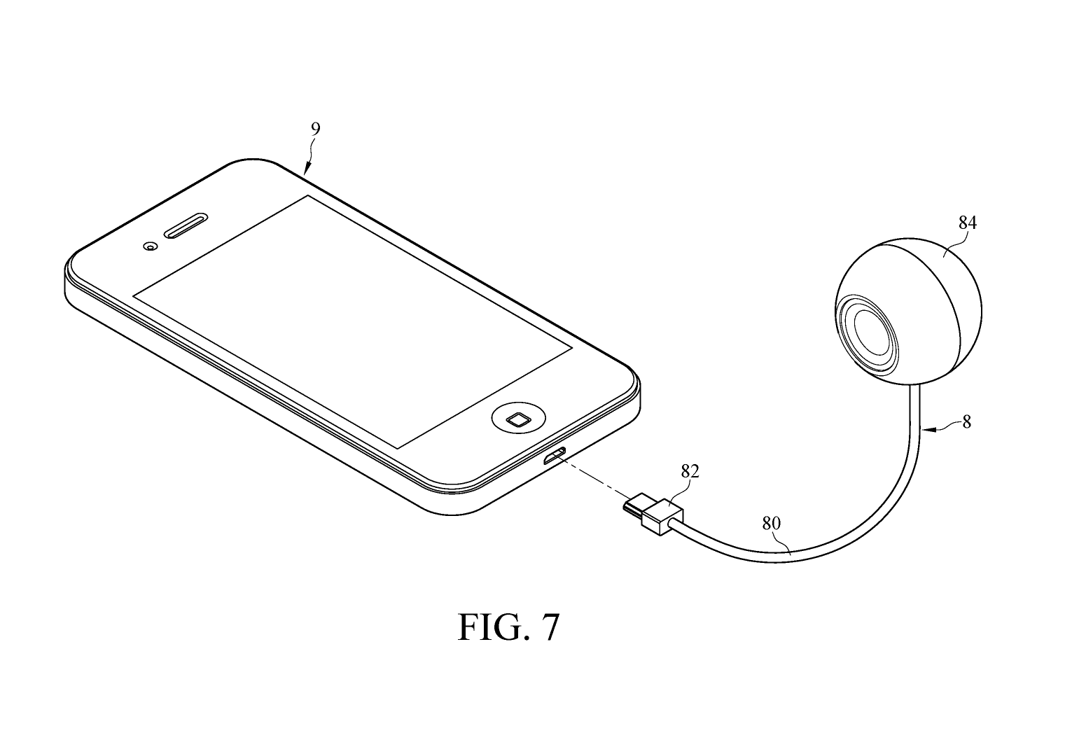

Please refer to FIG. 7. FIG. 7 is a schematic view of a camera with a flexible transmission line according to an embodiment of the disclosure. As shown in FIG. 7, a camera 8 includes a flexible pipe sleeve 80 (referred to as flexible transmission line), a first connector 82 and a camera lens assembly 84. The first connector 82 and the camera lens assembly 84 are disposed to two opposite ends of the flexible pipe sleeve 80 and are electrically connected to each other via the transmission conductor on the inner side of the flexible pipe sleeve 80 or via other suitable transmission arrangements so that the camera lens assembly 84 is electrically connected to a mobile device 9, such as a smart phone, a tablet computer, a laptop computer, or other suitable device.

The transmission protocol of the first connector 82 is the micro USB, the USB type A, the USB type B, the USB type C or Lightning or is other transmission protocol adapted to connecting an electronic device, and this embodiment is not limited thereto. In practice, since the first connector 82 is used to electrically connect to the mobile device 9, the first connector 82 is, for example, a USB plug to plug in a USB socket on the mobile device 9.

When the camera 8 uses the first connector 82 as a supporting point to prop up the camera lens assembly 84, one end of the flexible pipe sleeve 80 is disposed on a plane via the mobile device 9 and the flexible pipe sleeve 80 is directly bended so that the other end of the flexible pipe sleeve 80 extends upward from the mobile device 9 to prop up the camera lens assembly 84. In other words, all of the flexible pipe sleeve 80, the camera lens assembly 84, the first connector 82 and the mobile device 9 do not contact the same plane together. The mobile device 9 and the flexible pipe sleeve 80 constitute a supporting stand to set up the camera lens assembly 84 so that the camera lens assembly 84 can be lifted up on a plane to capture images in the stability of the plane. Therefore, it may be avoided that the image quality is lowered by hand shaking if the user carries the mobile device 9 and the camera lens assembly 84 by hands to capture images.

In another usage situation, in addition to using the first connector 82 as a supporting point, the camera 8 further uses a part of the flexible pipe sleeve 80 as a supporting point. For example, when the flexible pipe sleeve 80 is bended to have a L shape, the bended portion of the flexible pipe sleeve 80 contacts and presses against a plane, one end of the flexible pipe sleeve 80 is disposed on the plane via the mobile device 9, and the other end of the flexible pipe sleeve 80 extends upward from the bended portion of the flexible pipe sleeve 80 to lift up the camera lens assembly 84. The bended portion of the flexible pipe sleeve 80 is not limited to have a ring shape or multi-ring shape. In fact, the camera with a flexible transmission line described in this embodiment has been explained in the aforementioned embodiments and thus, will not be explained again herein.

As described above, the camera lens assembly 84 is a cam with a camera lens in an embodiment. Optionally, the camera lens assembly 84 is a cam with two camera lenses in another embodiment, and the two camera lenses are disposed oppositely so that the camera lens assembly 84 can capture images of front and back scenes via the two camera lenses. For example, the camera lens is a fisheye lens. The disclosure does not intend to limit the design of the camera lens assembly 84, and all those having ordinary skill in the art can design the camera lens assembly 84 according to practical requirements.

This embodiment does not tend to limit the diameter of the flexible pipe sleeve and the weight of the camera. However, in an embodiment, the camera lens assembly is put in the accommodating space of a casing, and the maximum dimension of the casing except the connector sticking out of the casing is not larger than 5 cm. Because of the flexibility and material strength of the flexible pipe sleeve, the flexible pipe sleeve whose diameter is shorter than 5 mm is sufficient to lift up the camera whose weight ranges between 15 and 50 g and preferably ranges between 20 and 25 g.

In addition, a fill light means may be required sometimes when the user uses a flexible transmission line cooperating with a pluggable camera, e.g. the flexible transmission line 1 cooperating with the camera lens assembly 3 or the flexible transmission line 5 cooperating with the camera lens assembly 7 in the previous embodiments, or directly uses a camera with a flexible transmission line, e.g. the camera 8 in the previous embodiment, to capture images or record a video. To this end, the disclosure further provides a flexible transmission line with one or more fill light components. For example, the fill light component is a light emitting diode (LED) component including one or more LEDs and a related circuit. Optionally, other types of fill light components may be contemplated in this or some embodiments. The deposition of the one or more fill light component is described in detail below.

For convenience, the flexible transmission line 1 and the camera 8 in the previous embodiments are taken for the following exemplary description; and however, the disclosure will not be limited to them.

In the case of the flexible transmission line 1 in the previous embodiments, one or more fill light components 16 are further disposed to the flexible transmission line 1. The fill light component 16 is electrically connected to the first connector 12 so that the fill light component 16 is electrically connected to the mobile device 2 as the first connector 12 is connected to the mobile device 2. Therefore, the mobile device 2 can control the operation and turned-on/off of the fill light component 16.

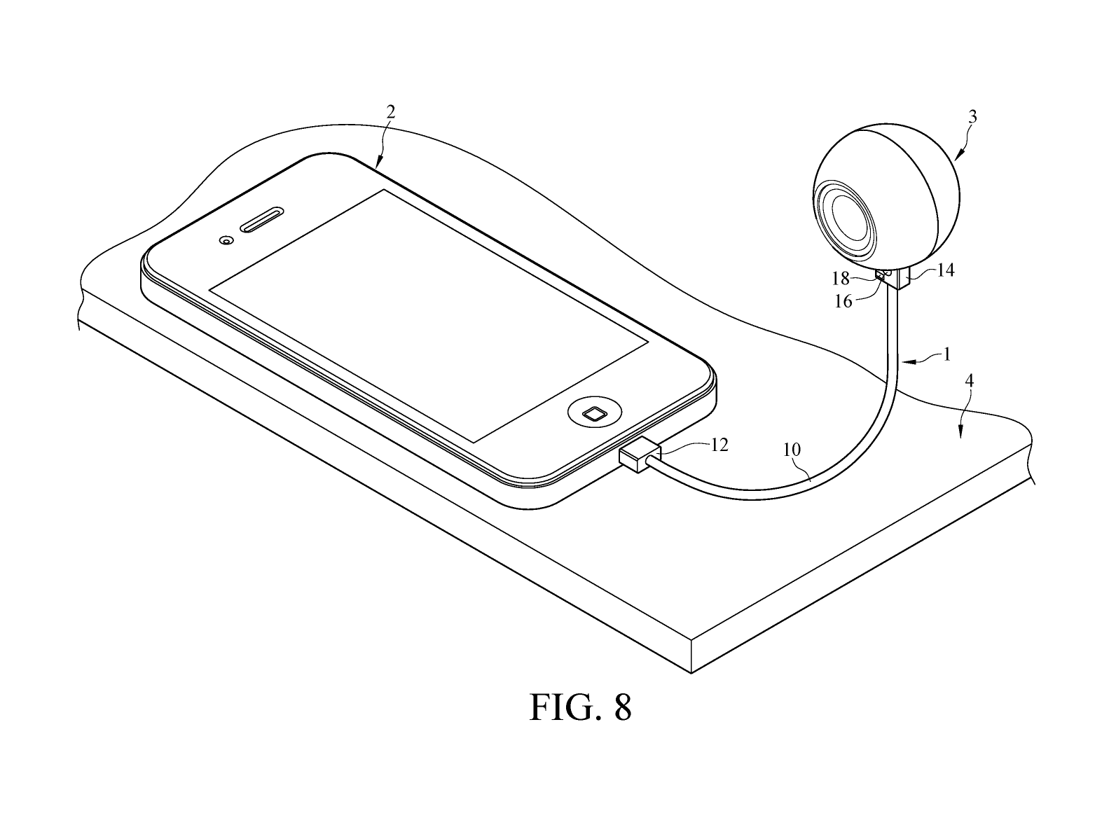

In an embodiment, the position of the fill light component 16 on the flexible transmission line 1 corresponds to the capturing direction of the camera lens assembly 3. Specifically, in an embodiment, the fill light component 16 is located at an end of the flexible transmission line 1 close to the camera lens assembly 3. For example, the fill light component 16 is disposed on the second connector 14, as shown in FIG. 8. Although the position of the fill light component 16 on the flexible transmission line 1 in FIG. 8 is on the second connector 14 and the number of fill light components 16 in FIG. 8 is one, the disclosure is not limited to this implementation and the position of the fill light component on the flexible transmission line and the number of fill light components can be designed according to practical requirements.

For example, if the camera lens assembly 3 is a cam with two camera lenses disposed oppositely, the camera lens assembly 3 is disposed with, for example, two fill light components 16 and the two fill light components 16 are, for example, disposed oppositely at an end of the flexible transmission line 1 close to the camera lens assembly 3 and respectively correspond to the two camera lenses. Therefore, when both of the cameras of the camera lens assembly 3 are enabled to capture the foreground image and the background image, the fill light components 16 corresponding to the two cameras are capable of filling light for the foreground and/or the background.

In the case of the camera 8 in the previous embodiment, one or more fill light components 86 are further disposed to the camera 8. The fill light component 86 is electrically connected to the first connector 82 so that the fill light component 86 is electrically connected to the mobile device 9 as the first connector 82 is connected to the mobile device 9. Therefore, the mobile device 9 can control the operation and turned-on/off of the fill light component 86.

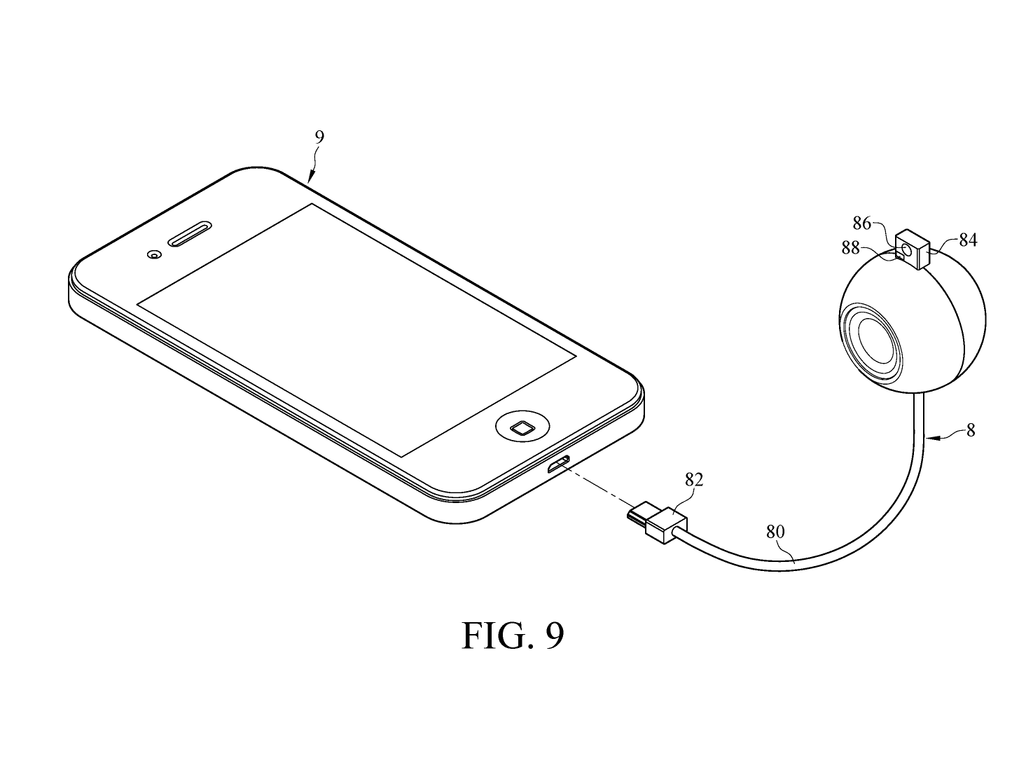

In an embodiment, the position of the fill light component 86 on the camera 8 corresponds to the capturing direction of the camera lens assembly 84. Specifically, in an embodiment, the fill light component 86 is disposed on the top of the camera lens assembly 84, as shown in FIG. 9. Although the position of the fill light component 16 on the flexible transmission line 1 in FIG. 8 is on the second connector 14 and the number of fill light components 16 in FIG. 8 is one, the disclosure is not limited to this implementation and the position of the fill light component on the flexible transmission line and the number of fill light components can be designed according to practical requirements. For example, the fill light component 86 is disposed around the camera lens of the camera lens assembly 84, or is disposed on the bottom of the camera lens assembly 84, or is disposed on the left or right side of the camera lens assembly 84.

In practice, if the camera lens assembly 84 is a cam with two camera lenses disposed oppositely, the camera lens assembly 84 is disposed with, for example, two fill light components 86, and the two fill light components 86 are, for example, disposed oppositely on the top of the camera lens assembly 84 and respectively correspond to the two camera lenses. Therefore, the fill light components 86 can provide supplementary light in photography or filming when enabled.

Furthermore, a light sensor may also be disposed to the aforementioned flexible transmission line or the aforementioned camera. The light sensor is able to sense ambient light around the camera lens assembly that is connected to the flexible transmission line. In an embodiment, the light sensor is electrically connected to the first connector so that the light sensor is electrically connected to a mobile device when the first connector is connected to the mobile device; and thereby, the mobile device can turn on/off the aforementioned fill light component or adjust the light intensity of the aforementioned fill light component according to the sensed ambient light. In another embodiment, the light sensor is further electrically connected to the aforementioned fill light component so that the aforementioned fill light component is automatically turned on/off in response to the sensing result of the light sensor or the light intensity of the aforementioned fill light component is automatically adjusted in response to the sensing result of the light sensor.

The position of the light sensor can be designed according to practical requirements. In an embodiment, the position of the light sensor on the aforementioned flexible transmission line or the aforementioned camera corresponds to the capturing direction of the camera lens assembly. In an embodiment, the light sensor is disposed on the aforementioned flexible transmission line. For instances, the light sensor is disposed at an end of the flexible transmission line close to or far from the camera lens assembly. In another embodiment, the light sensor is disposed on the aforementioned camera lens assembly. For example, the light sensor is disposed at a suitable position on the aforementioned camera lens assembly, such as the top, left side or right side of the aforementioned camera lens assembly, etc. The deposition of the light sensor is exemplarily described in detail below.

In the case of the flexible transmission line 1, a light sensor 18 is further disposed. In an embodiment, as shown in FIG. 8, the light sensor 18 is disposed on the second connector 14, and the light sensor 18 and the fill light component 16 are disposed on the same side of the second connector 14. In other embodiments, the light sensor 18 is disposed at other position on the flexible transmission line 1 according to practical requirements. In an example, the light sensor 18 is disposed on the first connector 12. In another example, the light sensor 18 and the fill light component 16 are disposed on different sides of the second connector 14.

In the case of the camera 8, a light sensor 88 is further disposed. In an embodiment, as shown in FIG. 9, the light sensor 88 is disposed on the top of the camera lens assembly 84. In other embodiments, the light sensor 88 is disposed at other position of the camera 8 according to practical requirements. In an example, the light sensor 88 is disposed on the first connector 82. In another example, the light sensor 88 is disposed on the left or right side of the camera lens assembly 84.

Although only one light sensor is disposed in FIG. 8 and FIG. 9, more than one light sensor may be disposed according to practical requirements. The disclosure does not intend to limit the number of light sensors. Further, either of the fill light component and the light sensor described in FIG. 8 or FIG. 9 may be used in other embodiments of the disclosure.

As set forth above, embodiments of the disclosure provide a flexible transmission line capable of immobilizing a camera lens assembly, and a camera with the flexible transmission line. The camera lens assembly is electrically connected to an image display device through a first connector. When the first connector is electrically connected to the image display device, the image display device and the flexible pipe sleeve can serve as a supporting stand to prop up and lift up the camera lens assembly on a plane so that the camera can be stabilized and immobilized via the image display device and the flexible pipe sleeve and is able to stay at a certain height for photographing. Therefore, it may be avoided that the image quality is lowered by hand shaking if the camera is carried by hands to capture images.

What is claimed is:

1. A flexible transmission line capable of immobilizing a camera lens assembly, comprising:
a flexible pipe sleeve;
a first connector disposed at an end of the flexible pipe sleeve; and
a second connector disposed at the other end of the flexible pipe sleeve and electrically connected to the first connector, and the second connector being pluggable to be electrically connected to the camera lens assembly;
wherein a portion of either the first connector or the flexible pipe sleeve is used as a supporting point to support the second connector.

2. The flexible transmission line according to claim 1, wherein the first connector and the second connector do not contact a same plane when the portion of either the first connector or the flexible pipe sleeve is used as the supporting point to support the second connector.

3. The flexible transmission line according to claim 1, further comprising:
a supporter, for allowing the flexible pipe sleeve to be disposed through, selectively sliding on the flexible pipe sleeve, and supporting the second connector in cooperation with the flexible pipe sleeve.

4. The flexible transmission line according to claim 3, wherein an external surface of the flexible pipe sleeve has a first positioning structure, the supporter has a second positioning structure corresponding to the first positioning structure, and the first positioning structure and the second positioning structure position the supporter at the external surface of the flexible pipe sleeve.

5. The flexible transmission line according to claim 3, wherein the supporter comprises a base section and an upright section, the base section and the upright section have an angle therebetween, and the base section and the upright section lead the flexible pipe sleeve to be curved to support the second connector.

6. The flexible transmission line according to claim 1, further comprising:
at least one cover for covering the outside of the flexible pipe sleeve and contacting at least one of the first and second connectors.

7. The flexible transmission line according to claim 1, further comprising:
a fill light component electrically connected to the first connector, for emitting supplementary light when the fill light component is enabled.

8. The flexible transmission line according to claim 7, further comprising:
a light sensor for sensing ambient light so that the fill light component operates in response to the ambient light sensed by the light sensor.

9. A flexible transmission line capable of immobilizing a camera lens assembly, comprising:
a flexible pipe sleeve;
a first connector disposed at an end of the flexible pipe sleeve; and
a second connector disposed at the other end of the flexible pipe sleeve and electrically connected to the first connector, and the second connector being pluggable to be electrically connected to the camera lens assembly;
wherein when the camera lens assembly is connected to the second connector, the flexible pipe sleeve is bendable to support the camera lens assembly, and a weight of the camera lens assembly is less than 25 g, and a maximum dimension of a case of the camera lens assembly is not longer than 5 cm.

10. The flexible transmission line according to claim 9, wherein a diameter of the flexible pipe sleeve is shorter than 5 mm.

11. A camera with a flexible transmission line, comprising:
a flexible pipe sleeve ;
a first connector disposed at an end of the flexible pipe sleeve; and
a camera lens assembly disposed at the other end of the flexible pipe sleeve and electrically connected to the first connector;
wherein a portion of either the first connector or the flexible pipe sleeve is used as a supporting to support the camera lens assembly.

12. The camera according to claim 11, wherein the first connector and the camera lens assembly do not contact a same plane when the portion of either the first connector or the flexible pipe sleeve is used as a supporting point to support the camera lens assembly.

13. The camera according to claim 11, further comprising:
a second connector disposed at an end of the flexible pipe sleeve far from the first connector, and the camera lens assembly being pluggable to be electrically connected to the second connector.

14. The camera according to claim 11, further comprising:
a supporter for allowing the flexible pipe sleeve to be disposed through, selectively sliding on the flexible pipe sleeve, and supporting the camera lens assembly in cooperation with the flexible pipe sleeve.

15. The camera according to claim 14, wherein an external surface of the flexible pipe sleeve has a first positioning structure, the supporter has a second positioning structure corresponding to the first positioning structure, and the first positioning structure and the second positioning structure position the supporter at the external surface of the flexible pipe sleeve.

16. The camera according to claim 14, wherein the supporter comprises a base section and an upright section, the base section and the upright section have an angle therebetween, and the base section and the upright section lead the flexible pipe sleeve to be curved to support the camera lens assembly.

17. The camera according to claim 13, further comprising:
at least one cover for covering the outside of the flexible pipe sleeve and contacting at least one of the first and second connectors.

18. The camera according to claim 11, wherein the camera lens assembly comprises a casing, a maximum dimension of the casing is shorter than 5 cm, and a weight of the camera lens assembly ranges between 15 g and 30 g.

19. The camera according to claim 11, further comprising:
a fill light component electrically connected to the first connector, for emitting supplementary light when enabled.

20. The camera according to claim 19, further comprising:
a light sensor for sensing ambient light so that the fill light component operates in response to the ambient light sensed by the light sensor.
